(19) United States
(12) Patent Application Publication
(10) Pub. No.: US 2015/0229746 A1
(43) Pub. Date: Aug. 13, 2015

(54) HANDHELD ELECTRONIC DEVICE CASE WITH FRONT COVER CAMERA OPENING

(71) Applicant: Thomas David BERGIN, Thousand Oaks, CA (US)

(72) Inventor: Thomas David BERGIN, Thousand Oaks, CA (US)

(21) Appl. No.: 14/179,116

(22) Filed: Feb. 12, 2014

(51) Int. Cl. H04M 1/02; H04B 1/3888

(52) U.S. Cl. CPC H04M 1/0283; H04M 1/0264; H04B 1/3888

(57) ABSTRACT

Some embodiments of the present invention include a case for an electronic device having a camera lens on a back surface of the device, the case having a front cover configured to cover a display screen of the electronic device when the electronic device is not in use, wherein the front cover does not block a camera lens on the back surface of the device when the front cover is open and positioned against the back surface of the device. To prevent the front cover from blocking the camera lens, embodiments of the front cover may have an orifice, a flap, or a cut-out portion.

### BACKGROUND

The embodiments herein relate generally to accessories for electronic devices, and more particularly, to a case including a front cover with a camera opening or reveal for an electronic device.

Users of handheld electronic devices, such as cell phones and tablets, often protect their devices and/or individualize their devices with a case or cover. Some conventional cases have a cover that attaches to the back of the electronic device and a cover that folds around and covers the front of the electronic device, when the device is not in use. In other words, many cases and covers are portfolio style, with the front cover flipping open to reveal the screen.

Many handheld electronic devices are used to take photographs and videos. Often times, the camera lens is located on the back, or the side opposite of the screen, of the electronic device. While the back surface of a conventional portfolio-style cover or case usually has an opening for the camera lens, when the front cover is fully opened held against the back of the device, the front cover blocks the lens, preventing a user from taking a photograph or video when the cover is fully opened.

Therefore, what is needed is a case or cover, which is used to cover an electronic device and has a front cover that protects the screen when the screen is not in use, that also enables a user to use the camera when the front cover is fully opened.

### SUMMARY

Some embodiments of the present invention include a case for an electronic device having a camera lens on a back surface of the device, the case having a front cover configured to cover a display screen of the electronic device when the electronic device is not in use, wherein the front cover does not block a camera lens on the back surface of the device when the front cover is open and positioned against the back surface of the device. To prevent the front cover from blocking the camera lens, embodiments of the front cover may have an orifice, a flap, or a cut-out portion.

### BRIEF DESCRIPTION OF THE FIGURES

The detailed description of some embodiments of the invention is made below with reference to the accompanying figures, wherein like numerals represent corresponding parts of the figures.

FIG. 1 is a perspective view of one embodiment of the present invention.

FIG. 2 is a rear perspective view of one embodiment of the present invention.

FIG. 3 is a perspective view of one embodiment of the invention, illustrating the front cover 14 in the open position.

FIG. 4 is a rear perspective view of one embodiment of the present invention.

FIG. 5 is a rear perspective view of one embodiment of the present invention.

FIG. 6 is a rear perspective view of one embodiment of the present invention, illustrating the folding of a corner flap 28.

FIG. 7 is a rear perspective view of one embodiment of the present invention, with a large corner flap 38 in an open position.

FIG. 8 is a rear perspective view of one embodiment of the present invention, with a center flap 44 in an open position.

FIG. 9 is a rear perspective view of one embodiment of the present invention.

FIG. 10 is a rear perspective view of one embodiment of the present invention.

FIG. 11 is a rear perspective view of one embodiment of the present invention.

### DETAILED DESCRIPTION OF CERTAIN EMBODIMENTS

In the following detailed description of the invention, numerous details, examples, and embodiments of the invention are described. However, it will be clear and apparent to one skilled in the art that the invention is not limited to the embodiments set forth and that the invention can be adapted for any of several applications.

The device of the present disclosure may be used to enable a user to use the camera on an electronic device even when the electronic device is held in a case and a front cover of the case is fully open. The device of the present disclosure may comprise the following elements. This list of possible constituent elements is intended to be exemplary only, and it is not intended that this list be used to limit the device of the present application to just these elements. Persons having ordinary skill in the art relevant to the present disclosure may understand there to be equivalent elements that may be substituted within the present disclosure without changing the essential function or operation of the device.

1. Cover

2. Orifice, Reveal, or Cut-out

The various elements of the device for enabling a user to use a camera on an electronic device even when a case having a front cover is fully opened of the present disclosure may be related in the following exemplary fashion. It is not intended to limit the scope or nature of the relationships between the various elements and the following examples are presented as illustrative examples only.

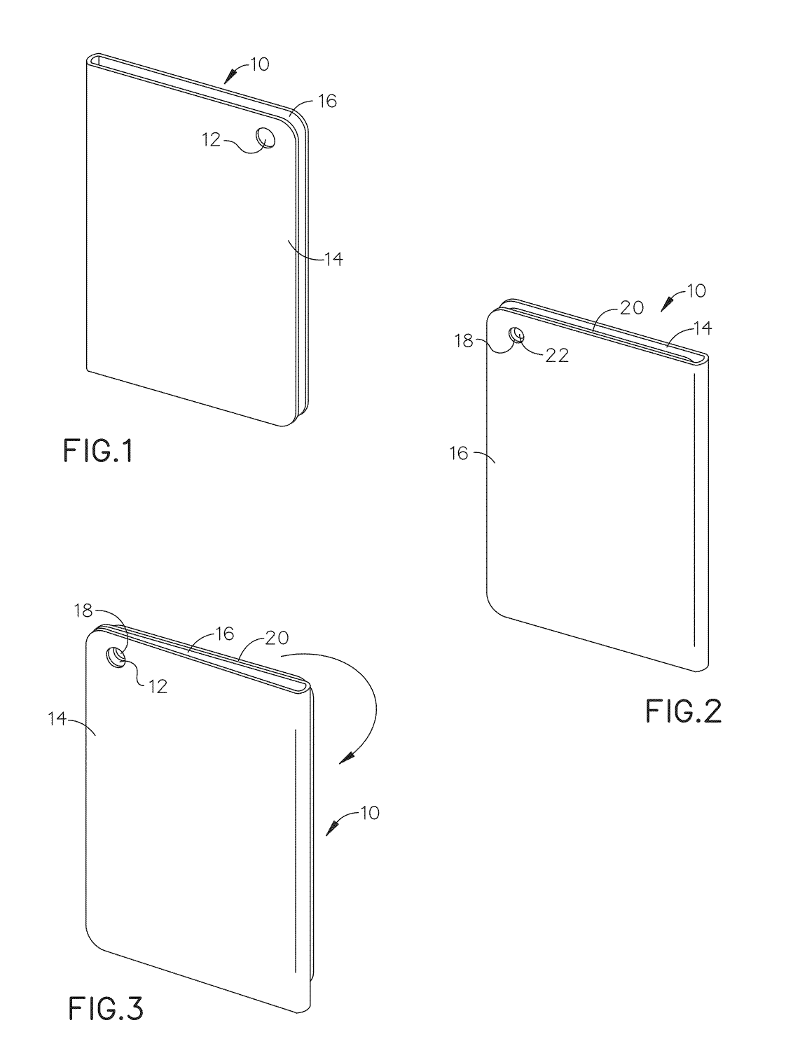

By way of example, and referring to FIGS. 1-11, some embodiments of the invention include a novel device for protecting an electronic device comprising a front cover 14, which may be configured to protect the electronic device's screen when the electronic device is not in use, and a back cover 16, which may be configured to protect the back of the electronic device. The back cover 16 may have an opening 18 that prevents the back cover 16 from blocking the camera lens 22. In embodiments, the front cover 14 also has an orifice, reveal, or cut-out that prevents the camera lens on the back of the electronic device from being blocked when the front cover 14 is fully opened.

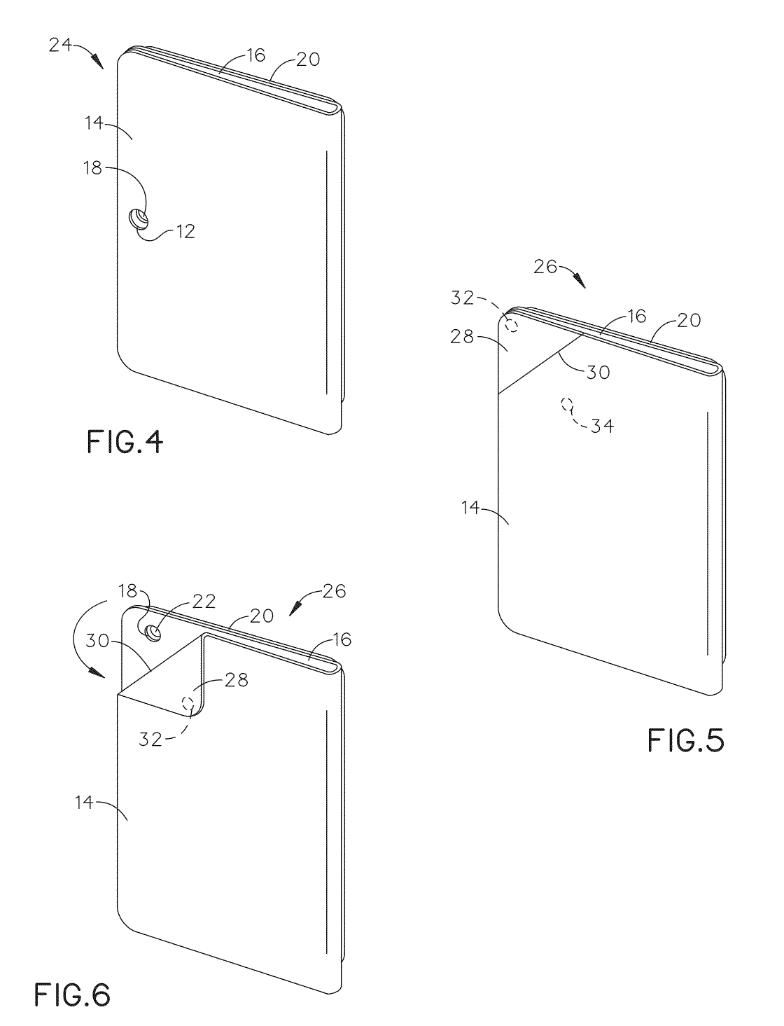

For example, as shown in FIGS. 1-4, the cover may be a punch-out case 10, wherein the front cover 14 may have an orifice 12 that, when the front cover 14 is fully opened, as shown in FIG. 3, aligns with the opening 18 on the back cover 16. As a result, a user can fully open the front cover 14, and the camera lens 22 may not be blocked by the front cover 14, allowing a user to take photographs and videos when the front cover 14 is fully open. As shown in FIGS. 1-3, for devices with a camera lens 22 located in a corner of the device, the orifice 12 may be located in the corner of a substantially rectangular-shaped front cover 14. Alternatively, as shown in FIG. 4, the orifice 12 may be positioned in a different location, such as in a central portion along the length of the front cover 14, to align with the electronic device's camera. Thus, in embodiments, the orifice 12 may be located anywhere on the front cover 14, as long as when the front cover 14 is fully opened, the orifice aligns 12 aligns with the camera lens 22.

As shown in FIGS. 1-4, the orifice 12 may be circular in shape. However, in other embodiments, the orifice 12 may be any shape, provided that the orifice 12 allows for the camera lens to not be blocked when the front cover 14 is fully opened. For example, the orifice may be oval-, diamond-, square-, rectangle-, triangle-, star-, heart-, flower-shaped, or any other desired shape.

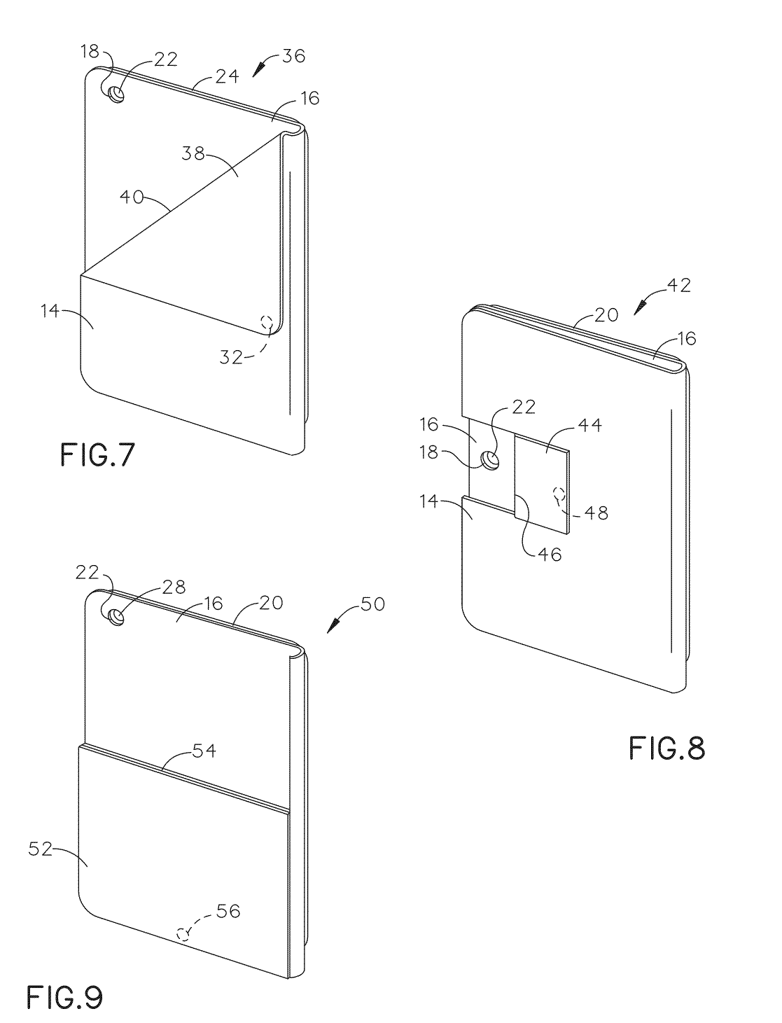

In other embodiments, such as those shown in FIGS. 5-9, the front cover 14 may have a flap designed to fold in a manner to reveal the camera lens 22. As with the cover having an orifice, the flap 44 may be located anywhere along the cover, such that when the flap is folded down, the camera lens 22 is revealed. For example, as shown in FIGS. 5 and 6, to cover may be a diagonal fold case 26, wherein the front cover 14 has a corner flap 28 configured to fold downwards at a fold line 30 to reveal the camera lens 22. In some embodiments, the corner flap 28 may include a flap fastener 32 that is configured to engage with a cover fastener 34 on the front cover. For example, the flap fastener 32 and the cover fastener 34 may be magnets. When a flap fastener 32 and a cover fastener 34 are included, the fasteners may aid in keeping the corner flap 28 folded downwards and away from the camera lens 22. In embodiments, the size of the corner flap 28 may vary. For example, as shown in FIG. 7, the corner flap 38 may be larger and, thus, the fold line 40 may be longer, than that shown in FIGS. 5 and 6.

Alternate embodiments of the front cover 14 with a flap designed to fold in a manner to reveal the camera lens 22 are shown in FIGS. 8 and 9. As shown in FIG. 8, a square fold case 42 may include a flap 44 that is square or rectangular in shape. For example, the flap 44, which may fold on fold line 48, may be located in a position to reveal a camera lens located on a side of the back surface of an electronic device. Alternatively, as shown in FIG. 9, the cover may be a horizontal fold case 50 having a flap 52 that folds along a horizontal fold line 54 to reveal the camera lens 22. Similar to the orifice in the covers having an orifice, the flap in covers having a flap may be any shape or size suitable for revealing the camera lens on the back of an electronic device when the flap is folded.

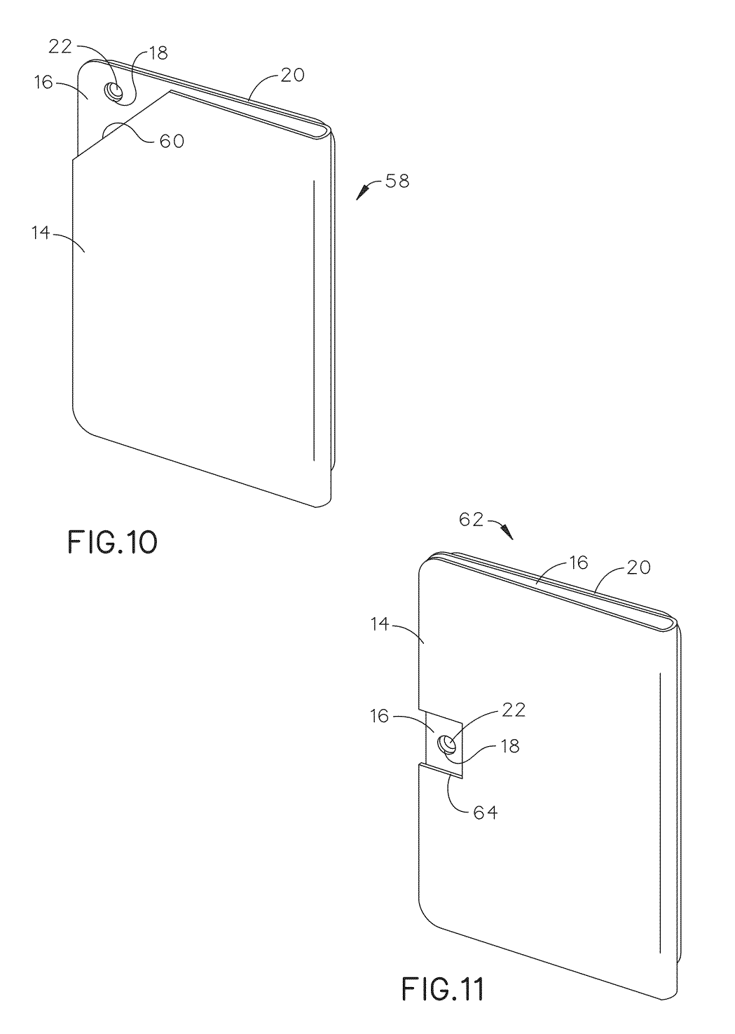

Other embodiments of a case having a front cover that does not block the back camera lens when fully opened include front covers comprising a solid shape with a cut-out portion, as shown in FIGS. 10 and 11. For example, as shown in FIG. 10, the cut-out case 58 may be substantially rectangular in shape other than a corner of the rectangle missing, the corner of the front cover 14 ending at a cut-out slot 60. Alternatively, the cut-out portion may be square in shape, as shown in the cut-out case 62 with a cut-out slot 64, as shown in FIG. 11. However, the cut-out portions of the front cover of the case may have any size or shape, such that when the front cover is fully opened, the front cover does not block the camera lens on the back of the electronic device.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A case for an electronic device having a camera lens on a back surface of the device, the case comprising:
a front cover configured to cover a display screen of the electronic device when the electronic device is not in use, the front cover having an orifice positioned to align with the camera lens on the back surface of the device when the front cover is open and positioned against the back surface of the device.

2. The case of claim 1, wherein the orifice has a shape selected from the group consisting of a circle, a square, an oval, a diamond, a rectangle, a triangle, a star, a heart, and a flower.

3. The case of claim 1, wherein:
the front cover is substantially rectangular in shape; and
the orifice is positioned proximate to a corner of the front cover.

4. The case of claim 1, wherein:
the front cover is substantially rectangular in shape; and
the orifice is positioned proximate to an edge of the front cover and equidistant from two corners of the front cover.

5. A case for an electronic device having a camera lens on a back surface of the device, the case comprising:
a front cover configured to cover a display screen of the electronic device when the electronic device is not in use, the front cover having a flap configured to fold along a fold line,
wherein when the front cover is opened and positioned along the back surface of the electronic device, the flap is configured to fold along the fold line to reveal the camera lens on the back surface of the device.

6. The case of claim 5, wherein the front cover is substantially rectangular in shape and the flap is positioned in a corner of the case, such that the flap is substantially triangular in shape.

7. The case of claim 5, further comprising:
a flap fastener located on the flap; and
a cover fastener located on the front cover,
wherein the flap fastener is configured to engage with the cover fastener to secure the flap in an open position.

8. The case of claim 7, wherein the flap fastener and the cover fastener are each magnets.

9. A case for an electronic device having a camera lens on a back surface of the device, the case comprising:
a front cover configured to cover a display screen of the electronic device when the electronic device is not in use, the front cover comprising a solid shape with a cut-out portion, the cut-out portion being configured to reveal the camera lens on the back surface of the device when the front cover is open and positioned against the back surface of the device.

10. The case of claim 9, wherein the cut-out portion has a shape selected from the group consisting of a triangle, a square, and a rectangle.
